(19) United States
(12) Patent Application Publication
(10) Pub. No.: US 2007/0004544 A1
(43) Pub. Date: Jan. 4, 2007

(54) Blade Tensioner

(75) Inventor: Kunihiko Mishima, Nabari-shi, Mie-ken (JP)

Correspondence Address: BORGWARNER INC., 3850 HAMLIN ROAD, AUBURN HILLS, MI, 48326, US

(73) Assignee: BORGWARNER MORSE TEC JAPAN K. K., Nabari-shi, Mie-ken (JP)

(21) Appl. No.: 11/420,043

(22) Filed: May 24, 2006

(30) Foreign Application Priority Data
May 30, 2005 (JP) 2005-156632

(51) Int. Cl. F16H 7/08; F16H 7/18

(52) U.S. Cl. 474/111; 474/140

(57) ABSTRACT

A blade-type tensioner 1 for imparting tension to a chain includes a blade shoe 2 with a chain sliding surface 20 that extends between the proximal end portion 21 and the distal end portion 22 of the blade shoe 2. The blade-type tensioner 1 further includes a blade spring 3 disposed opposite the chain sliding surface 20 of the blade shoe 2, and a bracket 5 that has a fixed pin 50 inserted into the pin aperture 21c of the proximal end portion 21 of the blade shoe 2 and that has a slide face 52 to slidably support the distal end portion 22 of the blade shoe 2. The proximal end portion 21 of the blade shoe 2 has a bulge portion 21d that bulges out toward the distal end portion 22 of the blade shoe 2. The bracket 5 has an extended portion 51 disposed at a position where the extended portion 51 overlaps with the bulge portion 21d of the proximal end portion 21 of the blade shoe 2 during operation of the blade-type tensioner 1 so as to restrict the lateral movement of the proximal end portion 21 of the blade shoe 2 along the pin 50.

### TECHNICAL FIELD

The present invention relates to a blade-type tensioner that can decrease the number of components and simplify the assembly process.

### DESCRIPTION OF THE PRIOR ART

Blade-type tensioners have been used to impart tension to chains such as timing chains or auxiliary drive chains for oil pumps in automotive engines. As shown in Japanese patent application laying-open publication No. 2000-234656, a blade-type tensioner of prior art is formed of a blade shoe having an arcuately curved chain sliding surface, a blade spring disposed opposite the chain sliding surface of the blade shoe, and a bracket that rotatably supports the proximal end portion of the blade shoe and that slidably supports the distal end portion of the blade shoe.

During operation of the blade-type tensioner, a spring force in accordance with the deformation of the blade spring is exerted on the chain through the blade shoe and thereby tension in the chain is maintained.

Typically, the bracket of the blade-type tensioner has a fixed pin to rotatably support the proximal end portion of the blade shoe. In the prior-art blade-type tensioner, after the proximal end portion of the blade shoe is installed to the pin, a washer is fitted on the tip of the pin, and thereafter the tip of the pin is caulked in order to prevent the proximal end portion of the blade shoe from falling out of the pin. Therefore, in the prior-art blade-type tensioner, the components are increased in number and the assembly process is complicated.

The present invention is directed to providing a blade-type tensioner that can decrease the number of components and simplify the assembly process.

### SUMMARY OF THE INVENTION

A blade-type tensioner according to one aspect of the present invention includes a blade shoe having a rotatably supported proximal end portion, a slidably supported distal end portion, and an arcuately curved chain sliding surface that extends between the proximal end portion and the distal end portion, a leaf-spring-shaped blade spring disposed opposite the chain sliding surface of the blade shoe and exerting a spring force on the chain through the blade shoe, and a bracket that has a fixed pin inserted into a pin aperture formed in the proximal end portion of the blade shoe and that has a slide face to slidably support the distal end portion of the blade shoe. The proximal end portion of the blade shoe has a bulge portion that bulges out toward the distal end portion of the blade shoe. The bracket has an extended portion that is disposed beside the bulge portion of the proximal end portion of the blade shoe during operation of the blade-type tensioner so as to restrict the lateral movement of the proximal end portion of the blade shoe along the pin.

According to the first aspect of the present invention, since the bulge portion is provided at the proximal end portion of the blade shoe and the extended portion is provided at the bracket, which is disposed beside the bulge portion of the blade shoe, by simply fitting the proximal end portion of the blade shoe to the pin of the bracket, prevention of the blade shoe from falling out of the pin can be achieved. This eliminates the necessity for providing the pin with a washer in use for prevention of fall-off of the blade shoe and for caulking the tip of the pin. Thereby, the number of components can be reduced and the assembly process can be simplified. Also, in this case, during operation of the blade-type tensioner, the proximal end portion of the blade shoe is guided by the bracket on both sides thereof.

A blade-type tensioner according to second aspect of the present invention includes a blade shoe having a rotatably supported proximal end portion, a slidably supported distal end portion, and an arcuately curved chain sliding surface that extends between the proximal end portion and the distal end portion, a leaf-spring-shaped blade spring disposed opposite the chain sliding surface of the blade shoe and exerting a spring force on the chain through the blade shoe, and a bracket that has a fixed pin inserted into a pin aperture formed in the proximal end portion of the blade shoe and that has a slide face to slidably support the distal end portion of the blade shoe. The bracket has an extended wall portion that is disposed beside the chain sliding surface of the blade shoe during operation of the blade-type tensioner so as to restrict the lateral movement of the proximal end portion of the blade shoe along the pin.

According to the second aspect of the present invention, since the extended portion is provided at the bracket, which is disposed beside the chain sliding surface of the blade shoe, by simply fitting the proximal end portion of the blade shoe to the pin of the bracket, prevention of the blade shoe from falling out of the pin can be achieved. This eliminates the necessity for providing the pin with a washer in use for prevention of fall-off of the blade shoe and for caulking the tip of the pin. Thereby, the number of components can be reduced and the assembly process can be simplified.

Preferably, the bracket is made of sheet metal.

The slide face of the bracket may have a pair of guide wall portions to guide the distal end portion of the blade shoe on both sides thereof. In this case, during operation of the blade-type tensioner, while the distal end portion of the blade shoe slides along the slide face of the bracket, the distal end portion of the blade shoe can be guided and supported by the pair of guide wall portions on opposite sides thereof. Thereby, the blade shoe can be guided more stably in cooperation with the guide by the bracket relative to the proximal end portion of the blade shoe.

A method for manufacturing the blade-type tensioner of the present invention includes the steps of inserting the pin of the bracket into the pin aperture of the proximal end portion of the blade shoe having the blade spring with the blade shoe tilted, and rotating the blade shoe around the pin till the distal end portion of the blade shoe comes into contact with the slide face of the bracket.

According to the method of the present invention, the blade shoe can be fitted to the bracket without interfering with the extended portion of the bracket, and thereafter the assemble man simply rotates the blade shoe around the pin to assemble the blade-type tensioner. In such a way, prevention of the blade shoe from falling out of the pin can be simply achieved.

### BRIEF DESCRIPTION OF THE DRAWINGS

FIG. 1 is a front elevational view of a blade-type tensioner according to a first embodiment of the present invention;

FIG. 2 is a front elevational view of a bracket constituting the blade-type tensioner of FIG. 1;

FIG. 3 is a top plan view of a portion of the bracket of FIG. 2;

FIG. 4 is a front elevational view illustrating the assembly method of the blade-type tensioner of FIG. 1;

FIG. 5 is a front elevational view of a blade-type tensioner according to a second embodiment of the present invention;

FIG. 6 is a front elevational view of a bracket constituting the blade-type tensioner of FIG. 5; and

FIG. 7 is a top plan view of a portion of the bracket of FIG. 6;

### DETAILED DESCRIPTION OF THE PREFERRED EMBODIMENTS

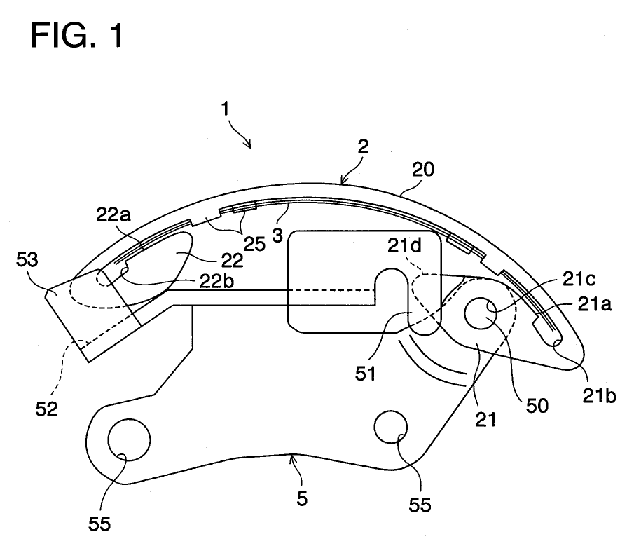

FIG. 1 shows a blade-type tensioner according to a first embodiment of the present invention. As shown in FIG. 1, a blade-type tensioner (1) includes a blade shoe (2) having an arcuately curved chain sliding surface (20), a plurality of leaf-spring-shaped blade springs (3) provided and stacked on the opposite side of the chain sliding surface (20) of the blade shoe (2) to exert a spring force on a chain (not shown) via the blade shoe (2), and a bracket (5), preferably made of sheet metal, to rotatably support the proximal end portion (21) of the blade shoe (2) and slidably support the distal end portion (22) of the blade shoe (2).

The blade shoe (2) has an indentation (21a) formed in the proximal end portion (21) to receive an end of the blade spring (3). The indentation (21a) has a concave portion (21b) to avoid interference with the end of the blade spring (3). Similarly, the blade shoe (2) has an indentation (22a) formed in the distal end portion (22) to receive the other end of the blade spring (3). The indentation (22a) has a concave portion (22b) to avoid interference with the end of the blade spring (3). On the opposite side of the chain sliding surface (20) of the blade shoe (2), a plurality of supporting members (25) are formed integrally with the blade shoe (2) to support the blade spring (3) on both sides thereof.

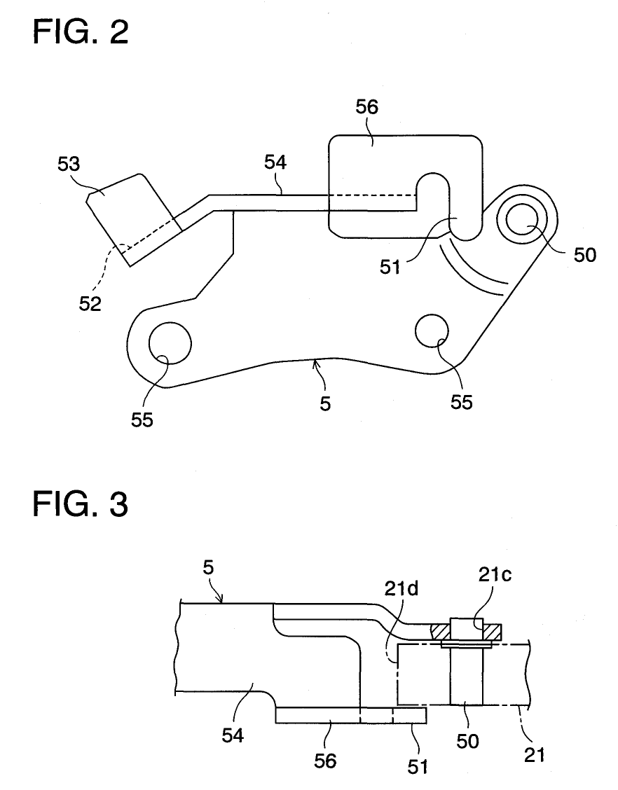

The proximal end portion (21) of the blade shoe (2) has a pin aperture (21c) formed thereinto. The bracket (5) has a pin (50) on one side thereof. An end of the pin (50) is fixed to the bracket (5) by welding, caulking or the like (see FIGS. 2 and 3). The pin (50) is inserted into the pin aperture (21c) of the proximal end portion (21) of the blade shoe (2). Also, the proximal end portion (21) of the blade shoe (2) has a bulge portion (21d) that bulges out toward the distal end portion (22) of the blade shoe (2). The bracket (5) has an extended portion (51) that extends toward and in the vicinity of the pin (50). The extended portion (51) of the bracket (5) is disposed beside the bulge portion (21d) of the proximal end portion (21) of the blade shoe (2) during operation of the blade-type tensioner (1) so as to restrict the lateral movement of the proximal end portion (21) of the blade shoe (2) along the pin (50).

The bracket (5) has a slide face (52) to slidably support the distal end portion (22) of the blade shoe (2). The distal end portion (22) of the blade shoe (2) has a convexedly curved bottom surface and the slide face (52) of the bracket (5) is generally flat in shape. The slide face (52) has a pair of guide walls (53) on opposite side edges thereof to guide the distal end portion (22) of the blade shoe (2).

As shown in FIGS. 2 and 3, the slide face (52) has a base face (54) extending at the back of the slide face (52). The base face (54) has an upraised wall (56) at the rear end thereof, which extends upwardly from a side edge of the base face (54). The extended portion (51) is integrally formed with the rear end of the upraised wall (56) and extends below the base face (54). Also, the bracket (5) has a plurality of bolt holes (55) formed therein to receive fitting bolts.

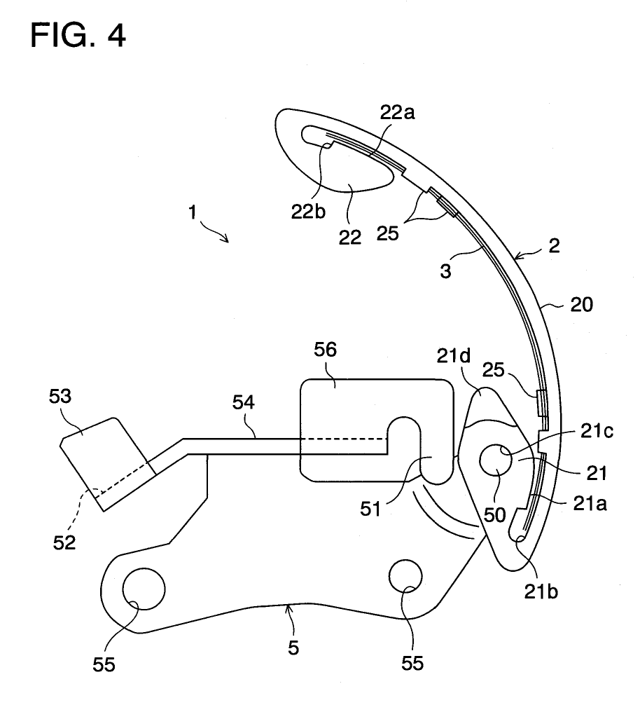

When fitting the blade shoe (2) to the bracket (5), as shown in FIG. 4, putting the blade shoe (2) upright with the blade springs (3) installed, the pin (50) of the bracket (5) is inserted into the pin aperture (21c) of the proximal end portion (21) of the blade shoe (2). At this time, beside the bulge portion (21d) of the proximal end portion (21) of the blade shoe (2), the extended portion (51) of the bracket (5) is not located, that is, the bulge portion (21d) is not overlapped with the extended portion (51). Thereby, installation of the proximal end portion (21) of the blade shoe (2) to the pin (50) of the bracket (5) can be carried out smoothly without interfering with the extended portion (51).

Then, the blade shoe (2) is rotated in the counterclockwise direction in FIG. 1 around the pin (50) till the distal end portion (22) of the blade shoe (2) comes into contact with the slide face (52) of the bracket (5) (see FIG. 1). At this time, on the lateral side of the bulge portion (21d) of the proximal end portion (21) of the blade shoe (2), the extended portion (51) of the bracket (5) is located (see FIGS. 1 and 3). In such a manner, installation of the blade shoe (2) to the bracket (5) has been completed.

During operation of the chain, the chain travels and slides along the chain sliding surface (20) of the blade shoe (2). At this time, elastic resilience in accordance with the deformation of the blade spring (3) acts on the chain through the blade shoe (2), and thereby tension in the chain is maintained.

Also, during operation, in the case where such force as to move the proximal end portion (21) of the blade shoe (2) sideways along the pin (50) is applied to the proximal end portion (21) due to oscillation of the chain, the proximal end portion (21) can be prevented from falling out of the pin (50) because the extended portion (51) of the bracket (5) is located at all times beside the bulge portion (21d) of the blade shoe (2). The opposite movement of the proximal end portion (21) along the pin (50) is restricted by the bracket itself. Also, with regard to the distal end portion (22) of the blade shoe (2), the guide walls (53) provided at the slide face (52) of the bracket (5) guides the distal end portion (22) of the blade shoe (2) at all times on both sides thereof, thereby preventing the distal end portion (22) from being disengaged from the slide face (52).

In such a manner, through the guide of the proximal end portion (21) of the blade shoe (2) by the extended portion (51) and bracket itself in cooperation with the guide of the distal end portion (22) by the guide walls (53), the blade shoe (2) can be guided more stably.

According to the first embodiment, since the bulge portion (21d) is provided at the proximal end potion (21) of the blade shoe (2) and the extended portion (51) is provided at the bracket (5) so as to be located beside the bulge portion (21d), by simply fitting the proximal end portion (21) of the blade shoe (2) to the pin (50) of the bracket (5), a fall-off of the blade shoe (2) from the pin (50) can be prevented with ease. This eliminates the necessity for providing a washer on the tip of the pin (50) in order to prevent a fall-off of the blade shoe (2) from the pin (50) and for caulking the tip of the pin (56), thereby reducing the number of components and simplifying the assembly process.

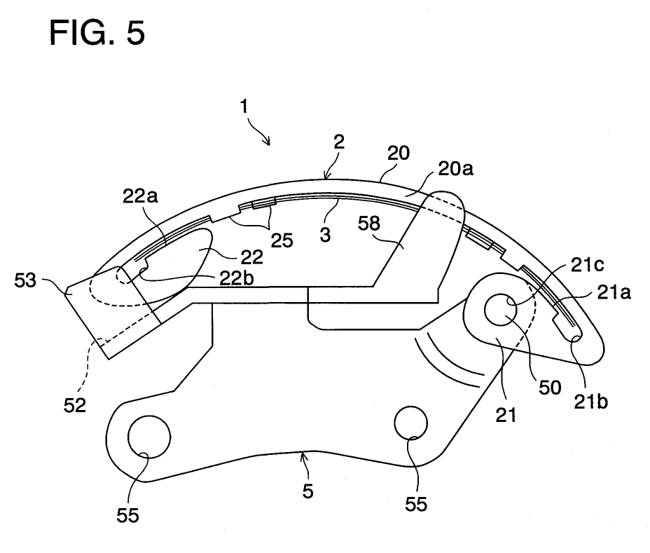

FIGS. 5 to 7 show a blade-type tensioner according to a second embodiment of the present invention. In these drawings, like reference numbers indicate identical or functionally similar elements.

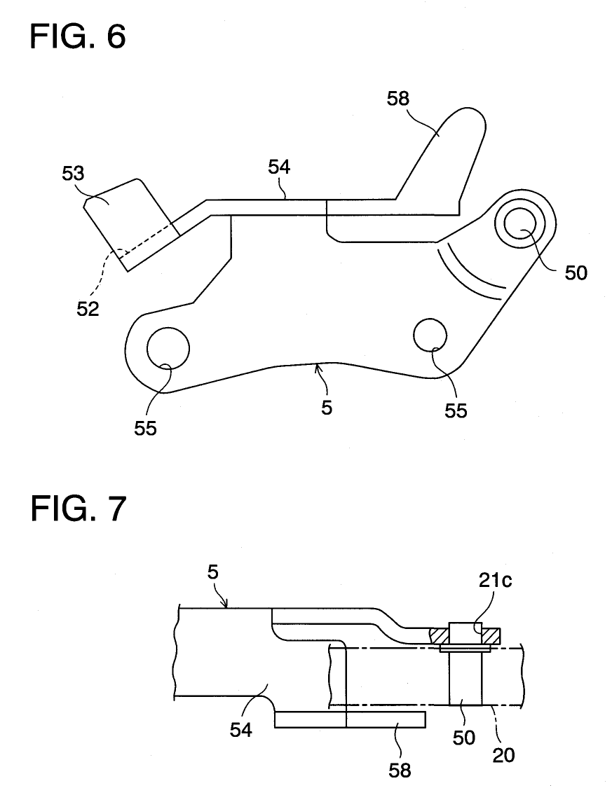

In the second embodiment, the extended portion provided at the bracket (5) is different in shape and position from that of the first embodiment. As shown in FIGS. 5 and 6, the base face (54) extending at the back of the slide face (52) of the bracket (5) has an upraised wall (58) provided at the rear end of the base face (54) and extending upwardly from a side edge portion of the base face (54). The upraised wall (58) is disposed beside the side surface (20a) of the chain sliding surface (20) of the blade shoe (2) and preferably extends over the chain sliding surface (20). The upraised wall (58) restricts the lateral movement of the blade shoe (2) caused by the travel of the proximal end portion (21) of the blade shoe (2) along the pin (50). In this case, the proximal end portion (21) of the blade shoe (2) does not have a bulge (21d) as shown in the first embodiment.

When fitting the blade shoe (2) to the bracket (5), the blade shoe (2) does not need to be tilted upright as shown in the first embodiment, and an assembly man has only to tilt the blade shoe (2) to the state where the blade shoe (2) and the blade spring (3) do not overlap with the upraised wall (58) of the bracket (5). Then, the pin (50) of the bracket (5) is inserted into the pin aperture (21c) of the proximal end portion (21) of the blade shoe (2). At this time, installation of the proximal end portion (21) of the blade shoe (2) to the pin (50) of the bracket (5) can be carried out smoothly without interfering with the upraised wall (58).

Then, the blade shoe (2) is rotated in the counterclockwise direction around the pin (50) till the distal end portion (22) of the blade shoe (2) comes into contact with the slide face (52) of the bracket (5). At this time, beside the chain sliding surface (20) of the blade shoe (2), the upraised wall (58) of the bracket (5) is located (see FIGS. 5 and 7). In such a manner, installation of the blade shoe (2) to the bracket (5) has been completed.

During operation of the chain, as with the first embodiment, the chain travels and slides along the chain sliding surface (20) of the blade shoe (2). At this time, elastic resilience in accordance with the deformation of the blade spring (3) acts on the chain through the blade shoe (2), and thereby tension in the chain is maintained.

Also, during operation, in the case where such force as to move the proximal end portion (21) of the blade shoe (2) sideways along the pin (50) is applied to the proximal end portion (21) due to oscillation of the chain, the proximal end portion (21) can be prevented from falling out of the pin (50) because the upraised wall (58) of the bracket (5) is located at all times beside the chain sliding surface (20) of the blade shoe (2). The opposite movement of the proximal end portion (21) along the pin (50) is restricted by the bracket itself. Also, with regard to the distal end portion (22) of the blade shoe (2), the guide walls (53) provided at the slide face (52) of the bracket (5) guides the distal end portion (22) of the blade shoe (2) at all times on both sides thereof, thereby preventing the distal end portion (22) from being disengaged from the slide face (52).

In such a manner, through the guide of the blade shoe (2) by the upraised wall (58) and bracket itself in cooperation with the guide of the distal end portion (22) by the guide walls (53), the blade shoe (2) can be guided more stably.

According to the second embodiment, since the upraised wall (58) disposed beside the chain sliding surface (20) of the blade shoe (2) is provided at the bracket (5), by simply fitting the proximal end portion (21) of the blade shoe (2) to the pin (50) of the bracket (5), a fall-off of the blade shoe (2) from the pin (50) can be prevented with ease. This eliminates the necessity for providing a washer on the tip of the pin (50) in order to prevent a fall-off of the blade shoe (2) from the pin (50) and for caulking the tip of the pin (50), thereby reducing the number of components and simplifying the assembly process.

1. A blade tensioner for imparting tension to a chain comprising:
a blade shoe having a proximal end portion, a distal end portion, and an arcuately curved chain sliding surface that extends between the proximal end portion and the distal end portion, wherein the proximal end portion has a pin aperture and a bulge portion that bulges out toward the distal end portion of the blade shoe;
at least one blade spring disposed opposite the chain sliding surface of the blade shoe for exerting a spring force on the chain through the blade shoe;
a bracket having a slide face to slidably support the distal end portion of the blade shoe; and
a fixed pin inserted into the pin aperture of the proximal end portion of the blade shoe;
wherein the bracket has an extended portion that is disposed beside the bulge portion of the proximal end portion of the blade shoe during operation of the blade tensioner to restrict the lateral movement of the proximal end portion of the blade shoe along the pin.

2. The blade tensioner of claim 1, wherein the bracket is made of sheet metal.

3. The blade tensioner of claim 1, wherein the slide face of the bracket further comprises a pair of guide wall portions to guide the distal end portion of the blade shoe on both sides.

4. The blade tensioner of claim 1, wherein the proximal end portion is rotatably supported and the distal end portion is slidably supported.

5. The blade tensioner of claim 1, wherein the blade spring is leaf-spring-shaped.

6. The blade tensioner of claim 1, wherein the blade spring comprises a plurality of blade springs.

7. A blade tensioner for imparting tension to a chain comprising:
a blade shoe having a proximal end portion, a distal end portion, and an arcuately curved chain sliding surface that extends between the proximal end portion and the distal end portion, wherein the proximal end portion has a pin aperture;
at least one blade spring disposed opposite the chain sliding surface of the blade shoe for exerting a spring force on the chain through the blade shoe;
a bracket having a slide face to slidably support the distal end portion of the blade shoe; and
a fixed pin inserted into the pin aperture of the proximal end portion of the blade shoe;
wherein the bracket has an extended wall portion that is disposed beside the chain sliding surface of the blade shoe during operation of the blade tensioner to restrict the lateral movement of the proximal end portion of the blade shoe along the pin.

8. The blade tensioner of claim 7, wherein the bracket is made of sheet metal.

9. The blade tensioner of claim 7, wherein the slide face of the bracket has a pair of guide wall portions to guide the distal end portion of the blade shoe on both sides thereof.

10. The blade tensioner of claim 7, wherein the proximal end portion is rotatably supported and the distal end portion is slidably supported.

11. The blade tensioner of claim 7, wherein the blade spring is leaf-spring-shaped.

12. The blade tensioner of claim 7, wherein the blade spring comprises a plurality of blade springs.

13. A method for manufacturing a blade tensioner comprising a blade shoe having a proximal end portion, a distal end portion, and an arcuately curved chain sliding surface that extends between the proximal end portion and the distal end portion, wherein the proximal end portion is rotatably supported and has a pin aperture and wherein the distal end portion is slidably supported, at least one blade spring disposed opposite the chain sliding surface of the blade shoe for exerting a spring force on the chain through the blade shoe, and a bracket having a slide face to slidably support the distal end portion of the blade shoe and comprising a fixed pin inserted into the pin aperture of the proximal end portion of the blade shoe comprising the steps of:
a) inserting the pin of the bracket into the pin aperture of the proximal end portion of the blade shoe while the blade shoe and the blade spring are tilted relative to the bracket; and
b) rotating the blade shoe around the pin until the distal end portion of the blade shoe comes into contact with the slide face of the bracket.

14. The method of claim 13, wherein the proximal end portion of the blade shoe further comprises a bulge portion that bulges out toward the distal end portion of the blade shoe; and wherein the bracket has an extended portion that is disposed beside the bulge portion of the proximal end portion of the blade shoe during operation of the blade tensioner to restrict the lateral movement of the proximal end portion of the blade shoe along the pin.

15. The method of claim 13, wherein the bracket has an extended wall portion that is disposed beside the chain sliding surface of the blade shoe during operation of the blade tensioner to restrict the lateral movement of the proximal end portion of the blade shoe along the pin.

16. The method of claim 13, wherein the blade spring is leaf-spring-shaped.

17. The method of claim 13, wherein the blade spring comprises a plurality of blade springs.
